(19) United States
(12) Patent Application Publication
(10) Pub. No.: US 2005/0284015 A1
(43) Pub. Date: Dec. 29, 2005

(54) Pathogen proof rodent trap

(76) Inventor: Gregory Greisman, Elkridge, MD (US)

Correspondence Address: ROSENBERG, KLEIN & LEE, 3458 Ellicott Center Drive, Suite 101, Ellicott City, MD, 21043, US

(21) Appl. No.: 11/103,975

(22) Filed: Apr. 12, 2005

Related U.S. Application Data
(60) Provisional application No. 60/583,857, filed on Jun. 29, 2004.

(51) Int. Cl. A01M 23/00

(52) U.S. Cl. 43/60

(57) ABSTRACT

A pathogen-proof and humane rodent trap that asphyxiates the rodent inside of a small airtight compartment so that the dead animal cannot act as a source for production or distribution of infectious organisms, and can be safely disposed of. Two embodiments are shown, one comprising two telescoping tubular members compressed together by a rubber band or the like, and a break-away bait stick is lodged between the two tubular members to hold them apart. When a rodent chews the bait stick it breaks away, compressing the tubular members together and sealing off the entrance aperture. In another embodiment, a single cantilevered tubular member is used, and it rests on a central fulcrum to allow tipping one way or another. A trap door is folded under one end of the tubular member and it snaps shut when the tubular member is tipped. Both designs are humane and sanitary, simple to use, effective, child and pet safe, small, disposable, and inexpensive to manufacture.

### CROSS-REFERENCE TO RELATED INVENTION(S)

The present application derives priority from U.S. Provisional Patent Application 60/583,857; filed: Jun. 29, 2004.

### BACKGROUND OF THE INVENTION

1. Field of the Invention

The present invention relates to rodent traps and, more particularly, to efficient and effective designs for rodent traps that produce a positively hermetic seal to trap a rodent and every associated contaminant (including urine, blood, feces, odors, fleas, ticks, mites, and infectious pathogens) inside of a small sealed container for safe and sanitary disposal. The traps also impart a humane death by asphyxiation.

2. Description of the Background

The true danger of rodents lies in the pathogens and parasites that they carry. The greatest deficiency of conventional rodent traps is that infectious pathogens can be transmitted to humans after the rodent has been trapped. Indeed, pathogen-carrying parasites often begin searching for another host even before their existing host is completely dead. No available trap completely prevents the leakage or exchange of every contaminant such as urine, blood, feces, odors, fleas, mites, ticks, and microscopic pathogens.

In just the last 10 years, 25 new diseases were added to the already existing list of 60 rodent to human transmissible diseases. As the world becomes densely populated and disease outbreaks become more problematic, the need for hygienic methods of rodent control will only intensify. At the same time, consumers are leaning toward more humane rodent traps that kill by less nihilistic methods. The traditional methods of poison, glue, electrocution, or crushing force violate emotional constraints and fail to control the aforementioned contaminants. Of particular importance, rodent fleas, ticks, and mites, a major source for transmission of infectious microbes from rodents to humans, are most likely to feed on humans when rodent control is being done because these tiny insects begin leaving their dying hosts within minutes in search of new hosts. The effect is that with unsealed traps, recently killed animals can be more infectious to humans than decomposing animals.

The best attempts to deal with these problems have been suffocation traps. U.S. Pat. No. 4,418,493 to Jordan issued Dec. 6, 1983 discloses an animal trap comprising a system of interconnected modular units including a gate, which is treadle operated by an entering animal to snap to a latch closed position from an open position adjacent the floor of the trap. The trap has a sealed capture module with a plastic bag liner, which may be disengaged from the system of interconnected modular units for disposal purposes.

U.S. Pat. No. 4,468,883 to Williams issued Sep. 4, 1984 shows a trap with a magnetic door frame which helps pull the door closed and keep it closed. A seal is formed by the door so that the trapped mouse will suffocate.

U.S. Pat. No. 5,327,673 to Paglia issued Jul. 12, 1994 shows a magnetic animal trap assembly in which the animal will suffocate. A magnetic door provides a seal when closed.

Unfortunately, these devices rely on relatively complex and expensive triggering and sealing mechanisms to trap the rodent. Although they claim suffocation, none of these devises claim to be impervious to the leakage of liquids or gases. It is very difficult to produce a 100% hermetic container using plastic bags or magnetic seals, especially in inexpensive, mass produced products. Most critically, the leakage of only a single drop of contaminated fluid from a trap can contain billions of infectious pathogens. Likewise, the leakage of the most minute amount of airborne pathogens can also result in contamination. To be effective for the control of rodent borne pathogens, a hermetic trap must be positively and reproducibly hermetic, and must remain securely closed after usage and disposal.

It would be greatly advantageous to provide a rodent trap that seals the rodent inside of a positively hermetically-sealed trap using a minimum of component parts. Because it is thus sealed, the dead animal cannot act as a source for production or distribution of pathogens, and can be safely disposed of while sealed inside of the trap. The present invention accomplishes the foregoing with a humane and sanitary rodent trap with a positively hermetic double seal that is simple to use, effective, child and pet safe, small, disposable, and inexpensive to manufacture. The present device kills the animal quickly, quietly, and humanely, eliminating the need for the traditional use of force, electricity, glue, or poison. The positive and secure hermetic seal allows the tripped trap to be left unchecked indefinitely without risk of any contamination, not only eliminating disease risks posed by unchecked traps, but adding convenience and efficiency to rodent control.

### SUMMARY OF THE INVENTION

It is, therefore, an object of the present invention to provide an improved rodent trap that seals the dead or dying rodent, as well as the associated parasites and pathogens, in a hermetic container to avoid contagion hazards as well as odors.

It is another object to provide to provide a more humane rodent trap that relies on quick asphyxiation and not poisons, neck-snapping, glue, or anything that could harm children or pets.

It is another object to provide a rodent trap that seals the rodent inside of an airtight hermetically-sealed trap using a minimum of component parts.

It is another object to provide a simple, inexpensive, safe, effective, and most importantly sanitary rodent trap with a simple operating mechanism, and a minimal volume to ensure that asphyxiation is extremely quick.

It is another object to provide a hermetically-sealed rodent trap by which rodents remain locked in a sealed tube and never have to be touched for discarding. The closed traps and rodents can be disposed of in a sterile manner.

These and other objects are accomplished by a rodent trap that seals the rodent inside of an airtight hermetically-sealed compartment so that the dead animal cannot act as a source for production or distribution of infectious organisms, and can be safely disposed of in the trap.

In one embodiment, the rodent trap comprises an outer tubular member that is open at one end and closed at the other, and an inner tubular member open at one end and closed at the other with at least one entrance aperture for the rodent proximate the closed end. The inner tubular member is telescopically inserted into the outer tubular member. A biasing member such as a rubber band is coupled between the inner tubular member and outer tubular member for compressing the two together. However, a novel break-away bait stick is lodged between the inner and outer tubular members to hold them apart such that the entrance aperture remains accessible to rodents. When a rodent enters through the entrance aperture to reach the bait stick and chews thereon, the bait stick will break away. The biasing member compresses the inner and outer tubular members together and seals off the entrance aperture.

In another embodiment, the rodent trap comprises a cantilevered tubular member closed at one end and open at the other for entry of the rodent. The tubular member includes a central fulcrum for resting on a surface and thereby allowing tipping one way or another; A trap door is hinged to the open end of the tubular member and articulates between a folded position beneath the tubular member and a closed position closing off the tubular member open end. A biasing member (rubber band) pulls the trap door from the folded position to the closed position upon release of the trap door from the folded position (this occurring by the rodent passing over the fulcrum and tipping the tubular member off the trap door).

In these and other embodiments the invention is hermetic, humane, sanitary, simple to use, effective, child and pet safe, small, disposable, and inexpensive to manufacture. It kills the rodent quickly, quietly, and humanely, eliminating the need for the traditional use of force, electricity, glue, or poison.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a side perspective view of a sterile and humane rodent trap 10 according to a first embodiment of the present invention.

FIG. 2 is a side exploded view of the sterile and humane rodent trap 10 of FIG. 1.

FIG. 3 is a side cross-sectional view of the sterile and humane rodent trap 10 of FIGS. 1-2 illustrating the flange 24.

FIG. 4 is a side perspective view of an alternative embodiment of a sterile and humane rodent trap 100 according to the present invention.

FIG. 5 is a side perspective view of the rodent trap 100 illustrating the hinge 136 and trap door 122 in a cocked position.

### DETAILED DESCRIPTION OF THE PREFERRED EMBODIMENTS

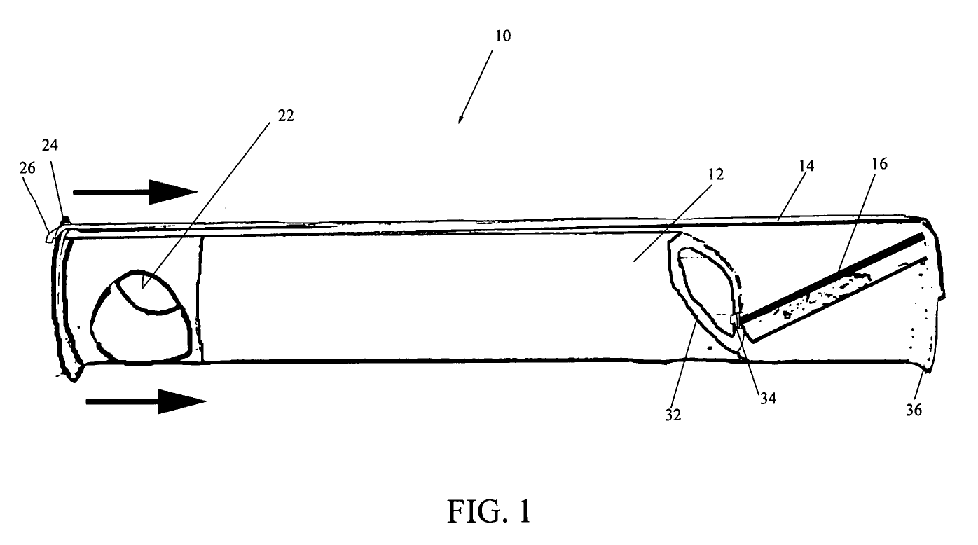

FIG. 1 is a side perspective view of a sterile and humane rodent trap 10 according to a first embodiment of the present invention. The rodent trap 10 generally comprises an outer tubular member 14 that is open and one end and closed at the other, a telescoping inner tubular member 12 open at one end and closed at the other, with at least one entrance aperture 22 for the rodent near the closed end, a biasing member 18 coupled to both the inner tubular member 12 and outer tubular member 14 and adapted for compressing the two together to complete the trapping action, and a break-away bait stick 16 by which a rodent initiates the trapping action. In use, the bait stick 16 is loaded by lodging between the corner at the closed end of the outer tubular member 14 and the edge of inner tubular member 12 as shown (the bait stick 14 may be pre-loaded as such at the place of manufacture), and then coupling the biasing member 18 between the inner tubular member 12 and outer tubular member 14 to compress the two, thereby retaining the bait stick 16 in place. It has been found that the simplest way to pre-load the bait stick 16 is to insert it on the floor of the outer tubular member 14, insert the inner tubular member 12 until the bait stick 16 is lodged, and then rotate the inner tubular member 12 with respect to the outer tubular member 14 approximately 180 degrees to arrive at the angled configuration as illustrated. The rodent trap 10 is then placed where a rodent will encounter it. A rodent will enter the trap through door 22 to reach the bait stick 16. When the rodent nibbles part way through the bait stick 16 it snaps due to the compressing force of the biasing member, allowing the inner tubular member 12 and outer tubular member 14 to slide together. This closes and seals off the aperture 22, forming the primary hermetic seal, and traps the rodent therein. The rodent dies humanely of asphyxiation in a short time.

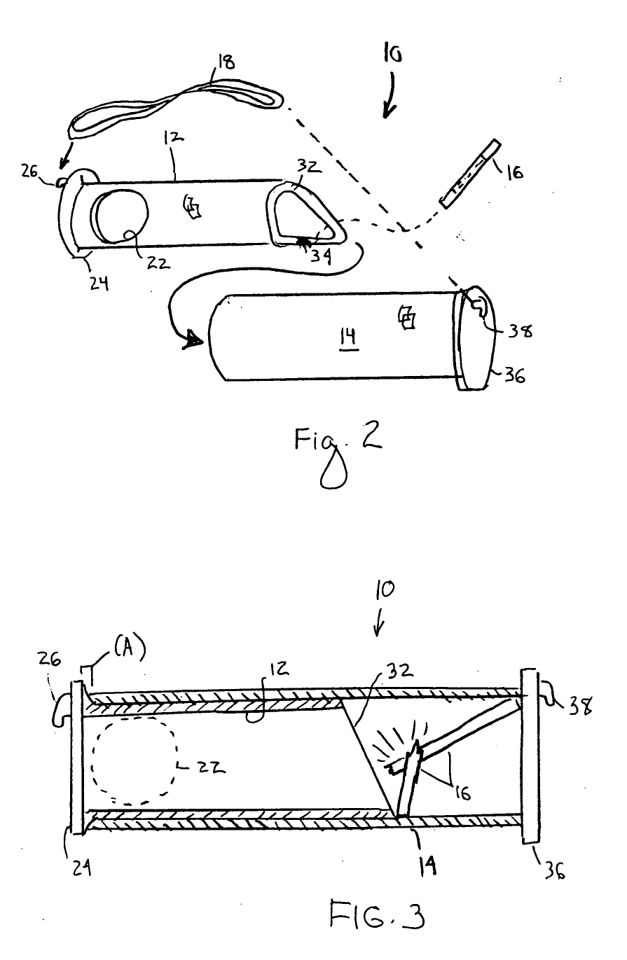

FIG. 2 is a side exploded view of the sterile and humane rodent trap 10 of FIG. 1. The inner tubular member 12 is closed at one end by a tapered flange 24 and open at the other end, the open end being insertable into outer tubular member 14. The extent of inner tubular member 12 may be formed with a cylindrical cross-section as shown, or alternatively may be formed with a rectilinear cross-section such as a triangle, square, pentagon, hexagon, octagon, spiral, or otherwise as a matter of design choice. The use of the words “tubular” or “tube” throughout this specification are intended to mean a hollow member or section that is not necessarily cylindrical. In any such case the shape of inner tubular member 12 must fit closely inside the outer tubular member 14 and yet allow free telescoping motion. The tapered flange 24 serves as a stop to limit insertion into the outer tubular member 14, and also serves as the second of two sealing points to ensure the hermetic seal. Both tubular members 12, 14 are preferably formed of opaque plastic to give a visual indication of its contents, but may be formed of glass, cardboard or any other structurally suitable material.

FIG. 3 is a side cross-sectional view of the sterile and humane rodent trap 10 of FIGS. 1-2 illustrating the flange 24. Preferably, the junction of the flange 24 with the extent of inner tubular member 12 is tapered as shown at (A). The purpose of the tapered flange (A) is several-fold: 1. The taper provides the stop for the sliding motion of the tripped trap and does so in a silent manner that eliminates the typical slamming or snapping sound of a typical trap that rodents quickly learn to avoid. 2. As the tubes spring towards the closed position, the taper acts to wedge the tubes together, forming the second hermetic seal. 3. As the tubes spring into the closed position, the taper acts to wedge the tubes together, locking them together with sufficient friction such that they are not easily or accidentally pulled apart during collection and disposal. The flange 24 may also have an integral catch 26 for the biasing member 18, which may be a conventional rubber band or spring. The inner tubular member 12 also has at least one (and preferably two opposing apertures 22 through which the rodents may gain entry for so long as the inner member 12 remains in its extended position. Aperture(s) 22 are preferably formed flush through the inner tubular member 12 so as to be closed tightly against the outer tubular member when slid therein. This ensures a second hermetic seal (supplemental to the flange 24), this double seal ensuring that no air or matter may enter or escape. The opposing end 32 of the inner tubular member 12 is angled downward toward the bottom, and the rim at the bottom is formed with a small notch 34 to seat the bait stick 16.

The outer tubular member 14 is likewise closed at one end and may include a flange 36 with feet or a flat footing to give the trap 10 a stable foundation on a flat surface. The flange 36 may also have an integral catch 38 for the biasing member 18. The open end of the outer tubular member 14 slides over the inner tubular member 12, the two being formed with conforming cross-sections to fit closely together and yet allow free telescoping motion.

The biasing member 18 couples both the inner tubular member 12 and outer tubular member 14 together and compresses them against the loaded bait stick 16. The biasing member 18 may be a simple rubber band, or a spring or any other suitable elastic member. The biasing member could be located on the outside or the inside of the trap. When the break-away bait stick 16 breaks, the trapping action comprises the inner tubular member 12 sliding freely into the outer tubular member 14.

The bait stick 16 has specific structural qualities and serves as a frangible strut when loaded to continue to hold the trap 10 open until a rodent nibbles and weakens it, at which point it collapses suddenly. In a preferred embodiment the bait stick 16 may be formed of small chips of meat, or other material attractive to an animal, compression molded together by a binder such as resin in the same manner that wooden particle board is made for lumber. The dimensions of the bait stick 16 approximate those of a conventional match stick. The controlled materials and dimensions result in a bait stick 16 that has a consistent and reproducible breaking strength under pressure. The bait stick 16 is preferably fashioned such that the animal must chew it near the center (where the supporting strength is weakest). This is accomplished either by concentrating the food or attractant near the center, or by coating the ends with a non-attractant coating. Inciting the rodent to chew the bait stick 16 in a focused area at the center will result in the most rapid failure. There are a number of advantages to using the bait stick 16 as a frangible supporting member. The trap 10 does not need to be baited or set by the user, but can come pre-baited and set from the factory. Because the bait itself serves as the holding device (rather than merely mounted on a holding device as in conventional traps), it is impossible for a rodent to eat the bait without springing the trap. Moreover, it eliminates the need for more complex, more expensive, and more failure prone triggering mechanisms as described above in the prior art. The bait stick 16 is designed for single use. It is destroyed upon use (the trap 10 cannot be reset and reused), thereby assuring that contaminated animals and traps remain enclosed upon disposal.

If desired the bait stick 16 can be impregnated with additives such as caffeine or epinephrine to increase metabolism and induce more rapid asphyxiation of the trapped animal. The bait stick could be ridged or tubular or otherwise shaped to be conducive to faster and more uniform structural failure.

In operation, when the break-away bait stick 16 breaks, the trapping action comprises the inner tubular member 12 sliding freely into the outer tubular member 14, thereby sealing off the apertures 22 and trapping the rodent therein. The double hermetic seal ensures that the rodent meets a timely and humane fate. Moreover, the double (redundant) hermetic seals ensure that once the trap 10 is sprung no air or matter, in particular fleas, mites, ticks, feces, urine, blood, pathogens, microbes, or odors can be exchanged between the inside and outside of the closed trap 10. Because it is sealed, the dead animal cannot act as a source for production or distribution of infectious organisms. Because of the hermetic seal, the trap 10 can be left unchecked indefinitely with no risk of contamination or unsanitary conditions. The hermetic seal results in quick asphyxiation, producing fast, painless, and non-traumatic death (unlike the traditional methods of poison, glue, electrocution, or crushing force) whereby the animal lays quietly in the trap and makes no attempt to chew or claw its way out, allowing for lightweight construction. Death from asphyxiation produces no obvious physiological symptoms, reduction of physical and intellectual performance occurs without the individual (even in humans) being aware. Because the trap is sealed, and because the animal feels no pain and quickly becomes increasingly stuporous the trapped animal makes no noise. Additionally, the trap itself makes no noise when tripped. These advantages greatly reduce the tendency of rodents to develop common evasive behavior known as trap shyness.

The above-described trap 10 design is simple and easy to manufacture, comprising only two open ended tubes 12, 14 connected by a band 22 or spring to pull them together. The trap 10 is also very robust and cannot be easily set off when setting the trap, by external jostling, or by animals climbing on or around the exterior of the trap. The tapered flange 24 results in the tubes being effectively stuck together after the trap is sprung, preventing inadvertent opening and loss of the hermetic seal which would result in exposure to contaminants and defeat the purpose of a hermetic trap. The trap can be set up on un-level or irregular surfaces and will operate in any position. The trap can easily be scaled for different sized animals. The trap can be modified for live capture if the outer tube is perforated.

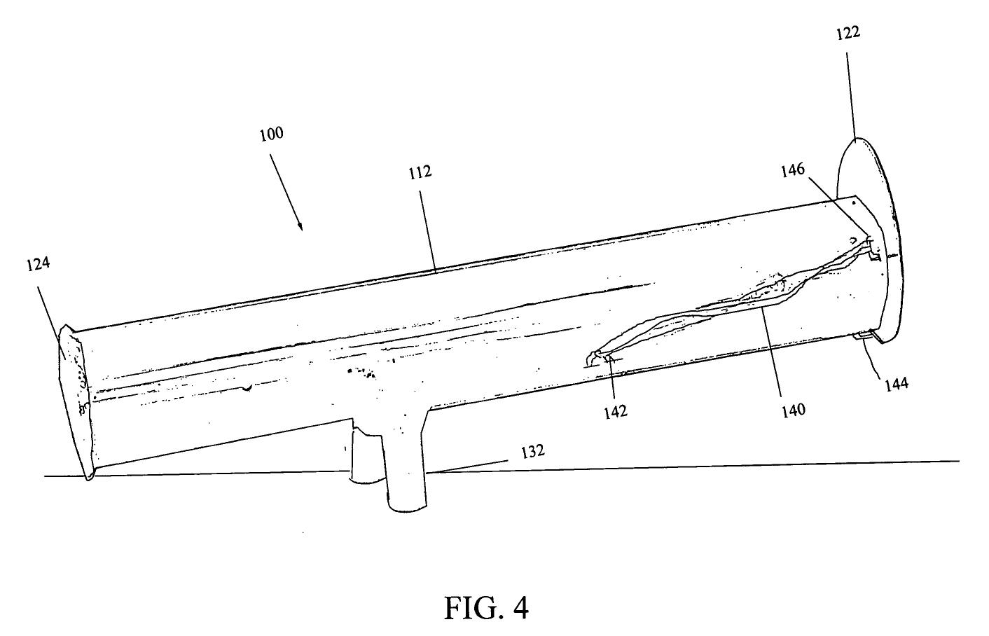

FIG. 4 is a side perspective view of an alternative embodiment of a sterile and humane rodent trap 100 according to the present invention. The rodent trap 100 generally comprises a cantilevered tubular member 112 closed at one end and open at another for entry of the rodent, the open end being closable by a trap door 122 for trapping the rodent. As before the tubular member 112 is preferably opaque to allow a vague view of the contents, and may be formed with a cylindrical cross-section as shown or alternatively with a rectilinear cross-section such as a square, pentagon, hexagon, octagon or otherwise as a matter of design choice. In this embodiment the tubular member 112 may be a conventional test tube. The tubular member 112 is cantilevered at the bottom center by legs 132 or any other fulcrum. The trap door 122 is preferably hinged to the rim of tubular member 112 at the open end. The hinge 144 may be a simple resilient flap joining the trap door 122 to the tubular member 112, and hinge 144 may be integrally molded with the tubular member 112 and trap door 122. The trap door 122 is biased closed against the open mouth of the tubular member 112 by a biasing member 140 coupled between the tubular member 112 and trap door 122. Again, the biasing member 18 may be a simple rubber band, or a spring or any other suitable elastic member. Biasing member 140 is attached at one end to the floor of tubular member 112 by a catch 142 which may be integrally molded to the floor, and is attached at the other end to the inside of the trap door 122 by a catch 146 which may be integrally molded to the trap door 122 (preferably at the exact center). The rodent trap 100 is placed where a rodent will encounter it, and is set by inserting some bait and sliding it to the closed end of tubular member 112 (the bait may be pre-loaded at the manufacturer). Next, the trap door 122 is opened against the bias of biasing member 140 and is tucked underneath the tubular member 112. When lying flat on a surface and cantilevered onto the cocked trap door 122, the weight of the tubular member 112 will retain the trap door 122 in its cocked position underneath the tubular member 112. This “setting” or “hold open” mechanism relies on the weight of the trap itself and, in addition, the trap door 122 is hidden under the trap, making it more inviting and less threatening to rodents.

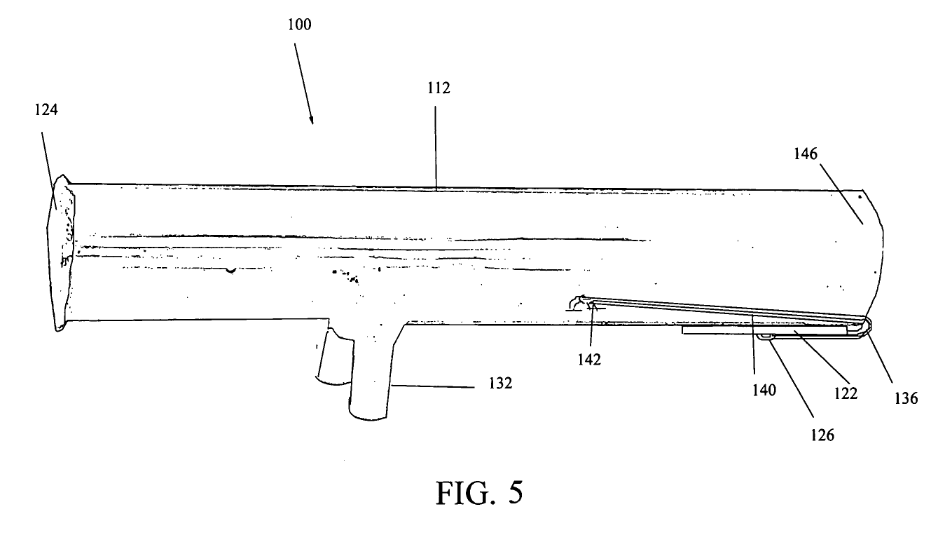

FIG. 5 is a side perspective view of the rodent trap 100 illustrating the hinge 136 and trap door 122 in a cocked position. The rodent has free access to the bait through the open end of the tubular member 112. However, once it crosses the fulcrum of legs 132 its weight will cause the tubular member 112 to tip downward at the closed end 124, and upward at the open end. The upward tilting at the open end allows the trap door 122 a degree of freedom to begin to pivot closed, and once it begins to close the biasing member gains considerable leverage against the trap door 122 and the trap door will snap shut to entrap the rodent therein. Specifically, when the trap door 122 is fully open (270 degrees) the biasing member exerts minimal force for closure (the force instead being directed toward the hinge 144). However, when the rodent tips the trap 100, the trap door 122 gains freedom to close slightly, changing the angle with which the biasing member 140 pulls on the trap door 122, thereby resulting in a sudden and forceful closure of the trap door 122. Additionally, once the trap 100 has sprung, the orientation of the biasing member 140 across the end of the trap is such that a rodent attempting to back out of the trap will deflect the biasing member 140 causing it to pull the lid tighter still. The closure of the trap door 122 against the tubular member 112 not only traps the rodent therein, but also forms a hermetic seal. Consequently, the rodent dies humanely by asphyxiation. Unlike the embodiment of FIGS. 1-3, the trap door 122 forms just a single hermetic seal, but testing has shown that the tension of the biasing member 140 can be adjusted to ensure that no air or matter may enter or escape. It also helps that the catch 146 is centrally located in the trap door 122 so that the biased closure imparts an even pressure around the rim of the tubular member 112, ensuring a uniform seal. This embodiment is more amenable to being reset and reused, but is preferably discarded to assure that contaminated animals and traps remain enclosed upon disposal. It is also noteworthy that this embodiment may be formed from only three component parts 1) tubular member 112 (which may be a conventional test tube); 2) trap door 122 and hinge 144, and 3) biasing member 140.

In all of the foregoing embodiments and suggested variations, a simple, inexpensive, safe, effective, and most importantly clean rodent traps 10, 100 are disclosed with simple operating mechanisms that do not rely on poisons, neck-snapping, glue, or anything that could harm children or pets. Because the relative volume of the tubular trap is so small as compared to the rodent, asphyxiation is extremely quick. Thinner and lighter materials can be used because the rodent has very little time to chew or claw its way out of the trap, and this in turn results in low material costs. Moreover, the traps are hermetic: the rodents remain locked in a sealed tube and never have to be touched for discarding. The closed traps and rodents can be disposed of in a sterile manner. This is especially beneficial in locations where extra cleanliness is required, such as hospitals, restaurants, or food processing plants. Even if the trap is not checked regularly, the animal carcass is sealed away inside the tube for later disposal. It can be left set over weekends or vacation breaks, any place and any time that regular monitoring is not convenient.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. In all such cases an effective rodent trap is provided that imparts a humane death by asphyxiation in a positively hermetically-sealed container for sanitary disposal. It is to be understood, therefore, that the invention may be practiced otherwise than as specifically set forth in the appended claims.

1. A rodent trap, comprising:
an outer tubular member open at one end and closed at another end
an inner tubular member open at one end and closed at another end and inserted telescopically into said outer tubular member, said inner tubular member having at least one entrance aperture proximate the closed end;
a biasing member coupled between the inner tubular member and outer tubular member and adapted for compressing the tubular members together; and
a break-away bait stick for holding the inner and outer tubular members apart such that the entrance aperture is accessible by a rodent;
whereby when a rodent accesses said entrance aperture to reach said bait stick and chews thereon said bait stick will break away and said biasing member will compress said inner and outer tubular members together to seal off said entrance aperture.

2. The rodent trap of claim 1, wherein said inner and outer tubular members are both formed with a cross-section chosen from among a group comprising circle, oval, triangle, square, pentagon, hexagon, octagon, and spiral.

3. The rodent trap of claim 1, wherein said biasing member compresses said inner and outer tubular members together to form a first hermetic seal about said entrance aperture.

4. The rodent trap of claim 1, wherein said biasing member comprises any one from among the group consisting of a rubber band, spring or resilient member.

5. The rodent trap of claim 1, wherein the closed end of the inner tubular member is closed by a flange.

6. The rodent trap of claim 5, wherein the flange is tapered to form a hermetic seal against the mouth of said outer tubular member.

7. The rodent trap of claim 3, wherein the closed end of the inner tubular member is closed by a flange.

8. The rodent trap of claim 7, wherein the flange is tapered to form a second hermetic seal against the mouth of said outer tubular member.

9. The rodent trap of claim 8, wherein the flange is tapered to produce a securely wedged closure.

10. The rodent trap of claim 8, wherein the flange is tapered to mute trap closure.

11. The rodent trap of claim 1, wherein the open end of the inner tubular member is angled toward a notch to seat the bait stick.

12. The rodent trap of claim 1, wherein the closed end of said outer tubular member is closed by a flange comprising a footing to give the rodent trap a stable foundation on a flat surface.

13. The rodent trap of claim 1, wherein the bait stick comprises morsels of bait compression molded with a binder.

14. The rodent trap of claim 13, wherein the bait stick is molded in the shape of a matchstick.

15. The rodent trap of claim 14, wherein said morsels of bait are concentrated at a center of said bait stick to encourage chewing at said center.

16. A frangible bait stick for propping open a rodent trap until a rodent chews thereon, comprising morsels of bait compression molded with a binder in a frangible matchstick form.

17. The bait stick of claim 16, wherein said morsels of bait are concentrated at a center of said bait stick to encourage chewing at said center.

18. The bait stick of claim 14, wherein opposing ends of said bait stick are coated to encourage chewing at the center of said bait stick.

19. The bait stick of claim 14, further comprising a stimulant additive to increase metabolism and induce more rapid death in an asphyxiation trap.

20. A rodent trap, comprising a cantilevered tubular member closed at one end and open at another for entry of the rodent, said tubular member including a central fulcrum for resting on a surface and thereby allowing said tubular member to tip one way or another;
a trap door hinged to the open end of said tubular member and articulating between a folded position beneath said tubular member and a closed position closing said tubular member open end; and
a biasing member for pulling said trap door from said folded position to said closed position upon release of said trap door from the folded position by a rodent's weight pivoting said tubular member about said fulcrum.

21. The rodent trap of claim 20, wherein said trap door is hinged to the open end of said tubular member by a hinge comprising a resilient flap joining said trap door to the tubular member.

22. The rodent trap of claim 21, wherein said body, hinge and trap door comprises one integrally-molded component.

23. The rodent trap of claim 20, wherein said biasing member comprises any one from among the group consisting of a rubber band, spring or resilient member.

24. The rodent trap of claim 20, wherein the trap door forms a hermetic seal against the mouth of said tubular member.

25. A rodent trap, comprising:
a containment housing formed by a first member open at one end and a second member telescopically engaged in said open end of said first member, said containment housing having at least one entrance aperture formed therein, said entrance aperture being sealingly closed by displacement of said second member relative to said first member from a first position to a second position;
a elastic member coupled between said first and second members for applying a biasing force therebetween; and,
a bait stick disposed in said containment housing for holding said second member at said first position against said bias force, said bait stick including at least one rodent edible material and being adapted to structurally fail responsive to a rodent feeding thereon and thereby free said second member to be displaced by said bias force to said second position.

26. The rodent trap as recited in claim 25, wherein said second member has a tapered portion to sealingly engage an inner surface portion of said first member.

27. The rodent trap as recited in claim 26, wherein second member has a flange formed adjacent a distal end thereof, said tapered portion being formed adjacent said flange.

28. The rodent trap as recited in claim 25, wherein said entrance aperture is formed in said second member.

29. The rodent trap as recited in claim 25, further including a pair of catches respectively coupled to said first and second members for respectively engaging opposing ends of said elastic member.
